(19) United States
(12) Patent Application Publication
(10) Pub. No.: US 2007/0278911 A1
(43) Pub. Date: Dec. 6, 2007

(54) Bracing Arrangement for Furniture

(76) Inventors: William Ernest Taylor Vallance, Marlow (GB); Mark Sodarberg, Evergreen, CO (US); Gary Hammersiag, Steamboat Springs, CO (US); Hans-Georg Brade, Sonoma, CA (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 10/555,230

(22) PCT Filed: Apr. 23, 2004
(86) PCT No.: PCT/GB04/01789

§ 371 Date: Mar. 5, 2007

(30) Foreign Application Priority Data
May 2, 2003 (GB) 0310186.2

(51) Int. Cl. F16B 12/00

(52) U.S. Cl. 312/111

(57) ABSTRACT

A bracing arrangement for a piece of furniture comprises a wire (25) extending diagonally between and around a series of pulleys (26, 27, 28, 29, 30, 31) placed at strategic points on opposing side panels (20, 21). The ends of the wire are connected to an adjusting mechanism (32) which is fixed to a part (24) of the furniture. Adjustment of the mechanism allows the ends of the wire to be pulled together to tension the wire and brace the structure.

This invention relates to furniture and in particular, though not exclusively, to the sort of furniture that is sold in flat packs for home assembly.

Home assembly furniture such as shelving units, wardrobes and chests of drawers typically consist of a number of flat panels that are designed to be assembled and held together by releasable fasteners. It is important that such assemblies contain some means to stop them going “out of square” in use because, by their nature, they tend to be non-rigid structures. If the piece of furniture has a back panel, this will give the assembly rigidity and act to hold it square. For pieces of furniture without a back panel, however, some other bracing arrangement is required.

The present invention provides a bracing arrangement for a piece of furniture having a number of panels connected together in a generally rectangular form, said bracing arrangement comprising first means connected between two of the panels for applying a tensile force such as to tend to pull together one of the pairs of diagonally opposing corners of the piece of furniture, second means connected between two of the panels for applying a tensile force such as to tend to pull together the other pair of diagonally opposing corners of the piece of furniture, and tightening means for adjusting at least one of said tension applying means to enable the piece of furniture to be put under equal and opposite tensile forces.

By way of example, some embodiments of the invention will now be described with reference to the accompanying drawings, in which:

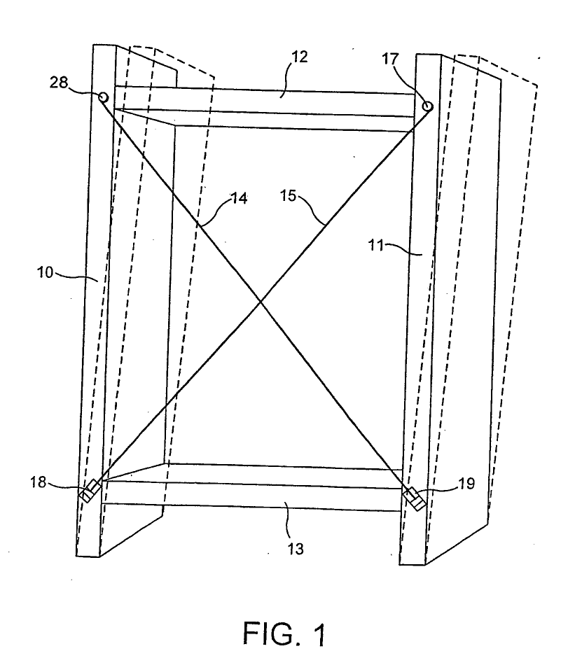

FIG. 1 is an illustration of a typical piece of home assembly furniture featuring a form of bracing arrangement according to the invention,

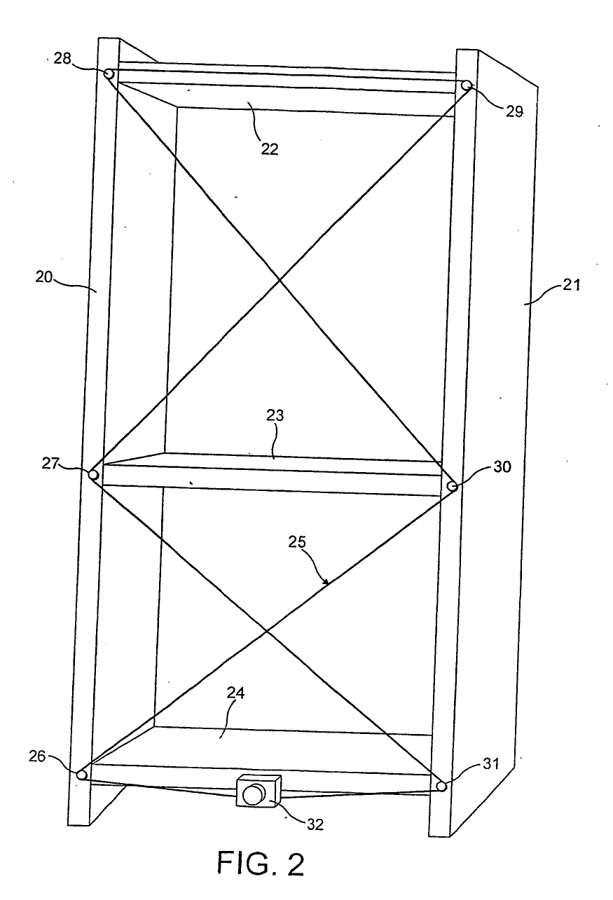

FIG. 2 illustrates another piece of furniture with a different form of bracing arrangement, and

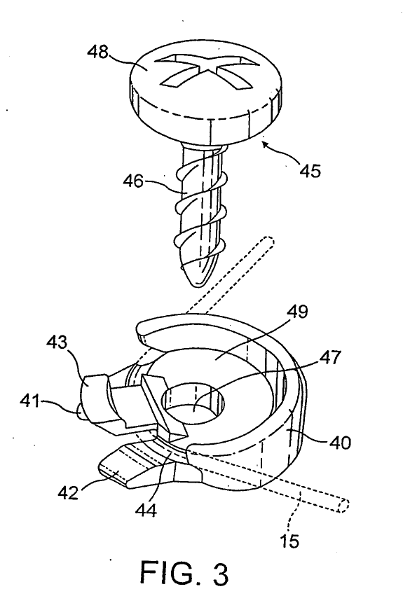

FIG. 3 illustrates a pulley with clamping device for the bracing arrangement of FIG. 2.

The piece of furniture seen in FIG. 1 is a simple shelving unit with side panels 10, 11, a top shelf 12 and a bottom shelf 13, all made of board material such as chipboard. The base 13 and shelf 12 are fitted to the side panels 10, 11 by cam and dowel fasteners, which are themselves well known in the art (for an example of a cam and dowel fastener, see our GB patent No. 2305226). The unit here has no other panels, in particular, it has no back board.

Whilst the cam and dowel fasteners are able to provide reasonably tight joints, it will be understood from the geometry of the structure in FIG. 1 that it is not rigid. There is nothing other than the strength of the joints to stop the unit going out of square, ie going into the shape of a parallelogram (as indicated in dashed lines in FIG. 1). This is undesirable not only from an aesthetic point of view, but also for safety concerns since, once the unit starts to lean in this way, it may possibly continue to do so until it collapses altogether.

The piece of furniture seen in FIG. 1 is fitted with a bracing arrangement. The bracing arrangement is designed to exploit the triangle principle in order to bring rigidity to what is otherwise effectively a non-rigid linkage. The bracing arrangement here comprises two flexible, yet substantially inextensible, tension elements 14, 15 extending between the side panels 10, 11 across diagonally opposite pairs of corners of the unit. The tension elements 14, 15 will typically be in the form of a wire cable, such as the inner element of a traditional Bowden cable. The tension elements 14, 15 are each anchored at one end by a respective pin 16, 17 at each top corner of the unit. At their other end, each tension element 14, 15 is attached to the unit by a respective bracket which incorporates an adjuster 18, 19. The adjusters 18, 19 can be operated to vary the tension in the tension elements 14, 15. Clearly, the tension in each tension element 14, 15 will be such as to tend to pull together the diagonally opposite pairs of corners of the unit between which the respective tension element extends, ie tending to collapse the unit. If, therefore, the two tension elements 14, 15 are adjusted so that each has the same tension, the unit will experience equal and opposite tensile forces, which will make it effectively rigid. That is to say, the unit will be prevented from moving from an initially square position into a skewed position such as that indicated in dashed lines in FIG. 1.

An alternative form of bracing arrangement is seen in FIG. 2. Here, the piece of furniture has side panels 20, 21 and top, middle and bottom shelves 22, 23, 24, the shelves being connected to the side panels by means of cam and dowel fasteners as before. The bracing arrangement here comprises a single flexible, yet substantially inextensible, tension element 25 which is trained around a number of pulleys 26-31 fixed to the side panels 20, 21 at or adjacent the points of connection of the shelves 22, 23, 24. As will be seen in FIG. 2, the tension element 25 is trained around the pulleys 26-31 in the manner of the lacing in a shoe, ie extending diagonally across from one side to the other and back again in the sequence 26, 30, 28, 29, 27, 31 (by pulley reference).

The two ends of the tension element 25 are connected to a tightening mechanism 32. The tightening mechanism 32 is an adjuster and can be operated to pull the ends of the tension element 25 together and hence in this arrangement, put the tension element under tension. A tightening mechanism that is suitable for this purpose is disclosed in U.S. Pat. No. 6,202,953.

The pulleys 26-31 are designed, initially at least, to allow movement of the tension element 25 that wraps around them (analogous to the eyelets for the lacing of a shoe). Thus, by adjusting the tightening mechanism 32, each of the diagonal spans of the tension element 25 will (ideally) be brought up to the same degree of tension. At this stage, the tension element 25 needs to be fixed at least two points relative to the unit, in order for it to act to hold the assembly rigid. One of the fixed points may be provided by anchoring the tightening mechanism 32 itself to the unit, eg by fixing it to the bottom shelf 24. For the other fixed point, one of the pulleys 26-31 may incorporate a clamping device to grip and hold the wrap of the tension element 25 around it.

A possible form of pulley with clamping device is seen in FIG. 3. The pulley is in the form of a washer 40, conveniently of moulded plastics material. The washer 40 has a bifurcated section formed by a pair of lower lugs 41, 42 and an upper lug 43. The tension element 1S wraps around the washer 40 in a groove 44 that extends partially around the circumference of the washer and in between the upper lug 43 and the two lower lugs 41, 42. The washer 40 is mounted to the piece of furniture by means of a screw 45, the threaded shank 46 of which extends through the bore 47 of the washer, and the head 48 of which sits in a recess 49 formed in the washer. The upper lug 43 sits somewhat proud of the bottom surface of the recess 49 so that when the mounting screw 45 is tightened down, this causes the upper lug 43 to flex downwardly, thereby clamping the tension element 15 between it and the two lower lugs 41, 42.

Other forms of pulley and clamping device could equally well be used. For example, it may be possible simply to use an ordinary screw, with the tension element initially being able to move around the shank of the screw, but being clamped between the head of the screw and the unit (possibly with a washer in between) when the screw is tightened down. The choice of pulley depends to some extent on the nature of the tension element. If the tension element is prone to “set”, ie suffer a permanent deformation if bent round too small a radius, for example, then using an ordinary screw as a pulley may not be suitable.

Many different forms of tension element could of course be used, their main criteria being that they are flexible, yet substantially inextensible. Typically, multi-stranded wire cable which has been pre-stretched could be used, but other products such as fishing lines may also be suitable.

When erecting home-assembly furniture, care must be taken to ensure that the unit goes together square, ie that the various panels are all connected together in a true rectangular form. For less experienced home-assemblers, it would be helpful to have some means with which to automatically square up a unit on its assembly. A bracing arrangement such as that shown in FIG. 2 could be adapted to provide for such a possibility. In this case, instead of a single tension element 25, two separate tension elements would be used. These would each be anchored at one of their ends to a respective top corner pulleys 28, 29, wrap around respective pairs of pulleys 30, 26 and 27, 31, and, be attached at their respective other ends to the tightening mechanism 32. The tightening mechanism 32 would itself be fixed in position relative to the unit, eg by connection to the underside of the bottom shelf 24. Now, if both of the tension elements are of substantially the same length, and if the tightening mechanism is located centrally and all the pulleys are arranged symmetrically, adjustment of the tightening mechanism to tension the two tension elements should automatically pull the unit square.

There may be occasions when the home assembler wishes deliberately to erect a unit out of square, for example to fit against an existing sloping wall or perhaps to match some existing furniture which itself is not square. This could be achieved with the bracing arrangement shown in FIG. 2, for example, by providing an adjustable support for attachment of the tightening mechanism 32, so that the position of the tightening mechanism is itself adjustable. The adjustable support would for example be capable of varying the lateral position of the tightening mechanism 32 relative to the side panels 20, 21. Shifting the lateral position of the tightening mechanism 32 away from its central position would alter the geometry of the bracing arrangement, with the result that the unit would find a different equilibrium position, with the tension in the two tension elements balanced, in an out-of-square position.

1. A bracing arrangement for a piece of furniture having a number of panels connected together in a generally rectangular form, said bracing arrangement comprising first means connected between two of the panels for applying a tensile force such as to tend to pull together one of the pairs of diagonally opposing corners of the piece of furniture, second means connected between two of the panels for applying a tensile force such as to tend to pull together the other pair of diagonally opposing corners of the piece of furniture, and tightening means for adjusting at least one of said tension applying means to enable the piece of furniture to be put under equal and opposite tensile forces.

2. A bracing arrangement as claimed in claim 1 wherein said tension adjusting means is arranged to operate automatically to pull the piece of furniture square.

3. A bracing arrangement as claimed in claim 1 and further comprising means for adjusting the position relative to square at which the piece of furniture becomes effectively rigid.

4. A bracing arrangement as claimed in claim 1 wherein the first and second tension applying means are separate elements.

5. A bracing arrangement as claimed in claim 4 wherein there is a single tightening means for adjusting the tension applying means and both said elements are connected to it.

6. A bracing arrangement as claimed in claim 1 wherein the first and second tension applying means are part of the same element, and said element is trained around pulley means attached to the piece of furniture.

7. A bracing arrangement as claimed in claim 6 wherein at least one said pulley means is lockable whereby optionally either to allow movement of said element therearound or else clamp said element to hold it in a fixed position relative to the pulley means.

8. A bracing arrangement as claimed in claim 1 and comprising means for attaching the tightening means to the piece of furniture.

9. A bracing arrangement as claimed in claim 8 wherein said attachment means allows adjustment of the position of the tightening means relative to the piece of furniture.

10. A bracing arrangement as claimed in claim 1 wherein said first and second tension applying means are each connected to the same two panels.

11. A piece of furniture comprising a bracing arrangement as claimed in claim 1.
